(19) United States
(12) Patent Application Publication
(10) Pub. No.: US 2025/0234450 A1
(43) Pub. Date: Jul. 17, 2025

(54) STABILIZED DIODE RADIATION SOURCE, AND LONG-LIFE ROTATING TARGET FOR HIGH-POWER PARTICLE BEAMS

(71) Applicant: Gold Standard Radiation Detection, Inc., Albuquerque, NM (US)

(72) Inventors: Mark DERZON, Albuquerque, NM (US); Paul REYNOLDS, Albuquerque, NM (US)

(21) Appl. No.: 19/022,960

(22) Filed: Jan. 15, 2025

Related U.S. Application Data
(60) Provisional application No. 63/621,781, filed on Jan. 17, 2024.

(51) Int. Cl. H05H 7/00

(52) U.S. Cl. CPC H05H 7/00; H05H 2242/10

(57) ABSTRACT

In one or more amendments, a particle accelerator has a particle beam source and a target. The particle accelerator is configured to output radiation in at least one pulse. The particle beam source has an electrode with an electrode surface. The electrode surface has a first portion and a second portion. The first portion of the electrode surface defines a spiral pattern with high spatial-frequency contours. The second portion of the electrode surface defines a spiral pattern with low spatial-frequency contours.

### CROSS-REFERENCE TO RELATED PATENT APPLICATION

This patent application claims priority to U.S. Provisional Patent Application Ser. No. 63/621,781, filed on Jan. 17, 2024 and titled” Stabilized Diode Radiation Source, and Long-Life Rotating Target for High-power Particle Beam,” which is incorporated by reference herein.

### FIELD

The disclosure relates generally to particle beam sources and targets. More specifically, the disclosure relates to particle beam sources and targets of particle accelerators with vastly increased peak powers and higher average power while extending the useful lifetime of the components.

### BACKGROUND

US-centric and worldwide efforts have gone into replacing stationary radiation sources with radiation sources that can be turned on and off. The goals are typically three-fold: (1) to reduce the threat of radiation dispersal devices and accidents, and increase general safety, (2) improve calibration services for x-ray sensors, food irradiation, and medical applications such as diagnosis and cancer treatment, and (3) to increase brightness.

New and improved radiation sources can also better fill needs in those applications above—x ray machines, ion beams, CAT scans, cancer treatment, industry, etc. Frequently the needs can be better filled at higher peak power, with short pulses or simply at higher average power.

Known systems for creating radiation sources for such purposes typically have a particle beam source, an accelerator region, and a target region. These conditions can produce significant heating and damage to surfaces and materials of the particle accelerator system. These damages can limit the practical applications.

Solid phase, gas phase and/or gas-filled diodes are often used as electron or ion sources. Using such sources repetitively has not been successful at very high current densities (e.g., greater than 0.1 A or >1 A/cm² over large areas, e.g. >0.5 cm²) in commercial applications because they do not have the longevity for commercial use. This can be due to the intense amount of power generated and the consequent damage to the source or target. Further, developing a hot plasma or high-energy deposition at any surface in a particle accelerator system can also lead to material erosion and limited lifetime.

For the past few decades, participants in this field often have been developing higher temperature materials and rotating anodes to disperse the heat over larger areas and to maintain lower temperatures and longer life. In addition to improving the peak performance of accelerators in a power-on-target or in emission features, there has been a push towards pulsed devices. In these pulsed devices, there is value in the source being turned on and then nearly immediately shut off (sometimes called extinction). For some applications, pulse trains are used. The rapid turn on and turn off or shutdown of the beam can result increased signal-to-noise in the detectors.

For the last few years most of the research has been in improving ECRH (Electron-Cyclotron Resonance Heating) or laser wakefield sources. ECRH sources offer long life but reaching current densities greater than 1A/cm² and areas greater than 1 cm in diameter are becoming exponentially more difficult as the desire for more total current and beam brightness increase. The ECRH pulse sources also tend to have long extinction times as the plasma lingers, which can be a problem when short pulses are desired.

FRX (Flash Radiography) machines with extended particle sources or various plasma pinch designs are frequently used to make bright bursts of radiation. Each of these FRX machines has lifetime and or reproducibility issues. Long refers to, for example, pulses longer than 1 ns-1000s ns. For pulsed applications where higher peak total currents and current densities are desired, a gap in capability still exists.

Laser wakefield accelerators are exceptionally bright, in terms of particles per second. But if large area sources with laser wakefield system brightness and larger numbers of particles are required, the technology may require many decades of further development.

As these beams of higher and higher power density are created, a gap in target survivability also exists. Materials in the targets can heat, spall, and otherwise fail in their surface features or bulk material characteristics. Replacing targets frequently can be expensive and time consuming.

In addition to the higher power and higher power density, greater accuracy in terms of measured output is desired.

Various rotating target anode designs are known. Limits exist, however, as to how much these known rotating anodes can improve performance; in addition, the target surface area impacted by the particle beam of known systems is typically limited by the pitting and other damage that occurs from irradiating the target with particle beams or lasers or other radiation beams.

Thus, a need exists for improved particle accelerator systems, including both pulsed and continuous particle accelerator systems with greater peak brightness, higher average power, improved accuracy and longer lifetimes.

### SUMMARY

In one or more embodiments, a particle accelerator has a particle beam source and a target. The particle accelerator can output radiation in at least one pulse. The particle beam source has an electrode with an electrode surface. The electrode surface has a first portion and a second portion. The first portion of the electrode surface defines a spiral pattern with high spatial-frequency contours. The second portion of the electrode surface defines a spiral pattern with low spatial-frequency contours.

In some embodiments, a method can include outputting radiation in at least one pulse from a particle beam source of a particle accelerator to a target of the particle accelerator, where the at least one pulse has a pulse between about 1 femtosecond and 10 microseconds. The particle beam source has multiple electrodes. A negative electrode can produce negative particles such as electrons. A positive electrode can produce positively charged ions.

In some embodiments, a bright particle accelerator accurately measures output and a target survives the intense bursts.

### BRIEF DESCRIPTION OF THE DRAWINGS

FIG. 1 shows a block diagram of a particle accelerator system with a particle beam source, an acceleration section, a target, a detector/sensor, and equipment to acquire and process data from a detector/sensor, according to an embodiment.

FIG. 2 shows a block diagram of an operational mode and algorithm to control the amount of radiation produced very accurately, according to an embodiment.

FIG. 3 shows an example pulsed train diagram, an example pulse train plot and an example dose plot to convey an example accuracy of pulse-based particle beam sources in achieving a desired dose.

FIG. 4 shows an example representation of the non-uniform distribution of hot spots spread across a known large area radiation source.

FIG. 5 shows an example representation of the resulting forces exerted by hot spots from a known large area radiation source.

FIG. 6 shows a shaped electrode surface of a particle beam source, according to an embodiment.

FIG. 7 shows a large area electrode assembly of the radiation source, according to an embodiment.

FIG. 8 shows a known rotating target, the axis of which is parallel to the direction of incident radiation and the surface of which is damaged.

FIG. 9 shows a cross-sectional side-view representation of a target, according to an embodiment.

FIG. 10 shows a cross-sectional side view of a target with a single coolant port, according to an embodiment.

FIG. 11 shows a cross-sectional side view of a target with two coolant ports, according to an embodiment.

FIG. 12 shows a top-down view of a target with coolant channels, according to an embodiment.

### DETAILED DESCRIPTION

One or more embodiments include or relate to more precise high peak current particle beam sources (also referred to herein as a source) that can provide intense radiation in single pulses or pulse trains. Not only can such embodiments for example provide stabilized longer life sources but targets can handle significantly higher power and have extended lifetime compared to known methods for providing intense pulsed beams.

In one or more embodiments, a short pulse radiation source is used in conjunction with a target for systems and methods to increase accelerator performance and lifetimes. These radiation sources can be generated via various techniques and various types of radiation can be applied to a target. The types of radiation that can be produced include for example ions, electrons, neutrons, and/or x-rays. Such embodiments can be used, for example, for medical treatment and other applications.

Known technologies have limits in lifetime, accuracy, peak and average currents, and current densities of various beam technologies. In contrast, one or embodiments can provide improved performance. The short pulses produced by one or more embodiments can provide the capability for adjustment, such as aiming or radiation dose-limiting where not desired, and an accurate determination of dose where radiation is desired. Further, one or more embodiments include a target for either a very high-power steady-state irradiation system, or intense burst system, and for enhancing the lifetime of pulsed irradiation targets. By providing greater surface area for pulsed particle beams to strike the target, the target lifetime can be greatly enhanced, and lifetime averaged costs reduced.

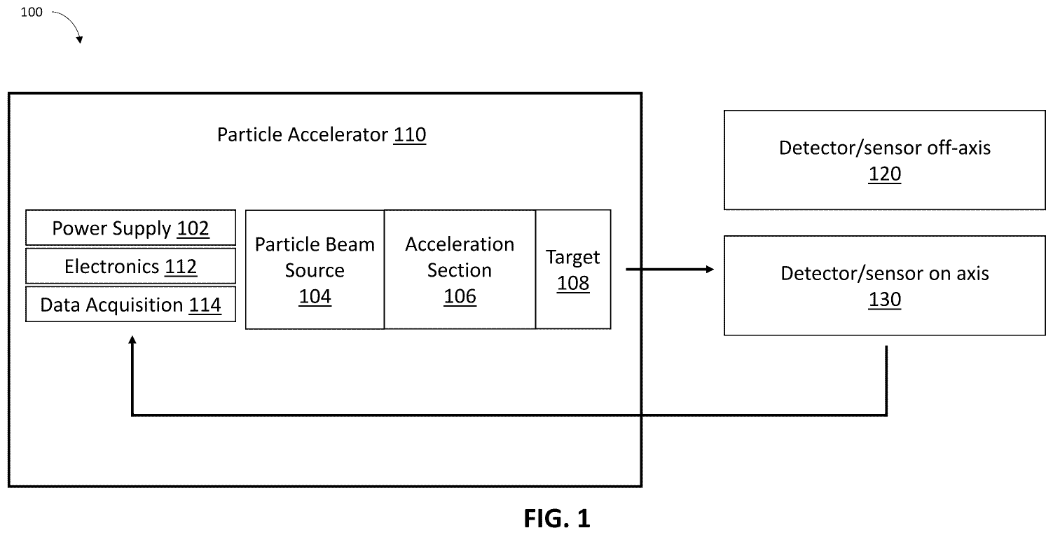

FIG. 1 shows a block diagram of a particle accelerator 110 of a particle accelerator system 100, according to an embodiment. The particle accelerator system 100 includes power supply(ies) 102, a particle beam source 104, an acceleration section 106, a target 108, electronics 112, and data acquisition system 114. Electronics 112 provide control of the power supply(ies) 102 to apply a bias across the electrodes to produce electric fields. In addition, electronics 112 includes electronics to control the timing of the multiple signals involved with and the power supplies 102 for the data acquisition of various diagnostics. Depending on the accelerator type (e.g., linac, linear transformer driver, applied field diode, etc.), the power supplies 102 are configured to operate the acceleration section 106. Any of these accelerator type can accelerate the particles between the particle source and the target; each accelerator type can have its own power supply 102. Electronics 112 can include electronics to control the bias between the source and the target. The electronics 112 and/or data acquisition system 114 have a processor and a memory that stores instructions that when executed by a processor perform certain methods/processes. Target 108 can include a detector/sensor that is off-axis or at arbitrary angles relative to the incident beamlets and target, or a detector/sensor that is on-axis to the incident beamlets. A particle accelerator system 100 can be implemented to measure a particle dose at a detector/sensor 120,130, from a periodic pulsed particle beam source 104 after firing at least one pulse. Data acquisition system 114, electronics 112 and power supply(ies) 102 can control the sending (firing, activation, etc.) of additional pulses until a desired particle dose is delivered to a target 108. Electronics 112, by controlling the number of pulses, can accurately provide the desired amount of radiation to be provided by the accelerator system.

Particle beam source 104 can be configured/structured to emit for example ions, or electrons. The targets are designed to provide photons, neutrons or other types of emission. In at least some implementations, the particle beam source 104 has an electrode with an emissive surface, and by means of an applied electric field can emit particles to be accelerated through a particle acceleration section 106 of particle accelerator 110. Electrode surface(s) of a particle beam source 104 can maintain higher peak and average power densities with lower material erosion, and lower temperature surfaces than the surfaces of known commercial sources. Thus, the particle beam source 104, acceleration section 106 and target 108 collectively can operate at higher peak and time-averaged current densities, as well as total current than known accelerators. These qualities enhance the lifetime number of operations, in-field usage, and other performance characteristics, and reduce the cost of operation. For example, a particle beam source 104 whose electrode surface(s) are operated at lower temperatures last longer. Furthermore, the electrode surface of this particle beam source 104 is scalable in area, such that the electrode surface can sustain higher total peak currents, because more surface area is engaged. Both the higher current densities and larger area mean that both higher peak and average currents can be sustained than with known sources.

In some implementations, a particle beam source 104 of a particle accelerator 110 can be implemented with a shaped electrode surface (also referred to herein as a cathode or anode surface). Shaping refers generally to contours that occur in regular patterns (e.g., a spiral pattern). More specifically, an embodiment of the shaped cathode surface includes portions with high spatial-frequency contours, which refers to the contour on the edges of the spiral pattern. The sharpness of the edges (e.g., the spatial frequency or roundness) of the spiral pattern can be controlled. If the edges are too sharp, like a burr, then the edges create a hot spot. If the edges are too smooth, then the edges creates a local electric field that is too low for particle emission. The sharpness of the edges of the spiral pattern can balance the magnetic and electric fields, moving spots along the spiral and limiting localized heating. In some implementations, a low spatial frequency refers to portions that lack a point with a geometric feature substantially less than 1 micron (for example, less than 0.1 microns) and/or a smoothness less than 20 microns. In some implementations, a high spatial frequency refers to portions that have a point with at least one of a geometric feature substantially less than 1 micron (for example, less than 0.1 microns) and/or a smoothness less than 20 microns. Geometric features substantially less than 1 micron and/or smoothness less than 20 microns can be considered sharp. A surface with portions that have a point with a smoothness less than 20 microns can be considered sufficiently smooth. During operation, the spiral pattern and contour features of a shaped electrode surface push material-destroying plasma away from unstable emission points, lowering local heating. In some implementations, electrode surfaces can be made from high atomic number refractive materials, electrical conductors, and thermal conducting materials such as tungsten metal, tungsten alloys, RHEAs (Refractory High Entropy Alloys), coated steel and other materials. In some implementations, liquid or gas-phase cathodes can be used as well. In some implementations, the surfaces can be fabricated using known machining, casting, etching sintering and other methods. The spiral-emission surface contour-controlled features push the plasma away from unstable emission lowering local heating. The manufacturability and scalability of these surfaces lend them to designable peak current systems that are highly scalable in area, unlike electron cyclotron resonance (ECR), simple tip systems, felt or thermal source emitters.

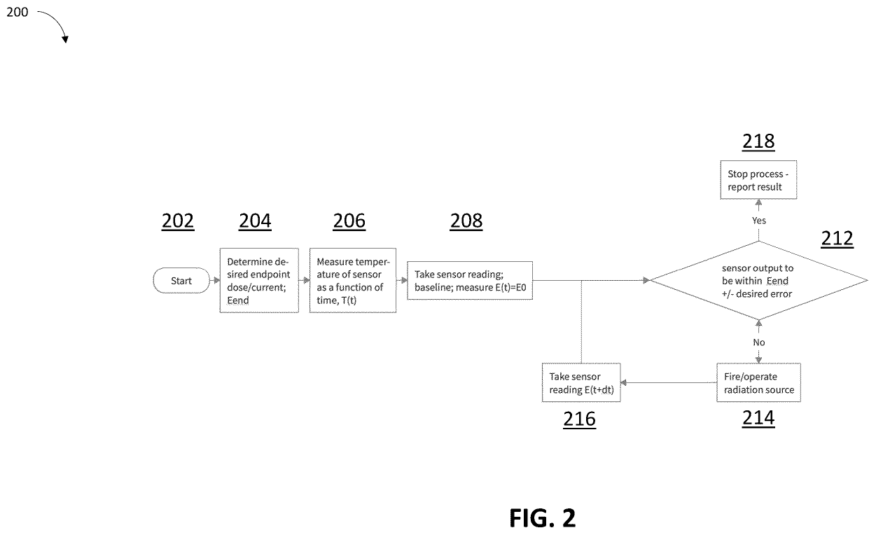

FIG. 2 shows a flow chart of an algorithm to reach a desired dose at higher accuracies than known sources and by a particle beam source (e.g., particle beam source 104 of FIG. 1) that fires at least one of a periodic pulse, according to an embodiment. Combined with the right sensor, the amount of radiation provided by a sequence of individually measured pulses can be controlled to a high degree of accuracy. This degree of accuracy cannot be easily obtained with a known steady-state or long pulse radiation source. The combination of multiple bursts with a radiation source that can be shut off between bursts limits the error and allows control of the total amount of radiation to a single burst. Doing this offers significant advantages, for example, to cancer treatment and numerous industrial applications.

In some implementations, a single pulse can be fired. In other implementations, many pulses can be fired. The algorithm 200 is an iterative approach to reaching the desired dose where the difference between individual dosages sets the absolute uncertainty. The process starts at 202. At 204, the input of the algorithm 200 is an indication of the desired dose or current, referred to herein as E_{end}. At 206, two quantities are read and tracked continually while the algorithm 200 is executing: the temperature of a dosage reading detector/sensor (e.g., detectors/sensors 120,130 of FIG. 1) as a function of time, T(t), and the dose/current as a function of time as recorded by that detector/sensor, E(t). At 208, a baseline or initial dose/current reading is measured as E0 and recorded. At 212, a calculation by a processor (e.g., the processor of the electronics 112 and data acquisition system 114 of FIG. 1) determines whether the detector/sensor output E(t) is within a desired error from the established E_{end}. If not, at 214, a particle beam source (e.g., particle beam source 104 of FIG. 1) send/fires an additional pulse. At 216, an additional detector/sensor reading E(t+dt) is taken, where dt is meant to describe a lapse in time from time t. At 212, an additional calculation by a processor determines whether the detector/sensor output E(t) is within the desired error from the established E_{end}. If not, then the process at 214, 216, and 212 a particle beam source send/fires an additional pulse and E(t+dt) is compared against E_{end} until such time that the dose E(t+dt) is within the desired error from the desired dose E_{end}. At 218, operation of the particle accelerator system 100 stops and the result is reported.

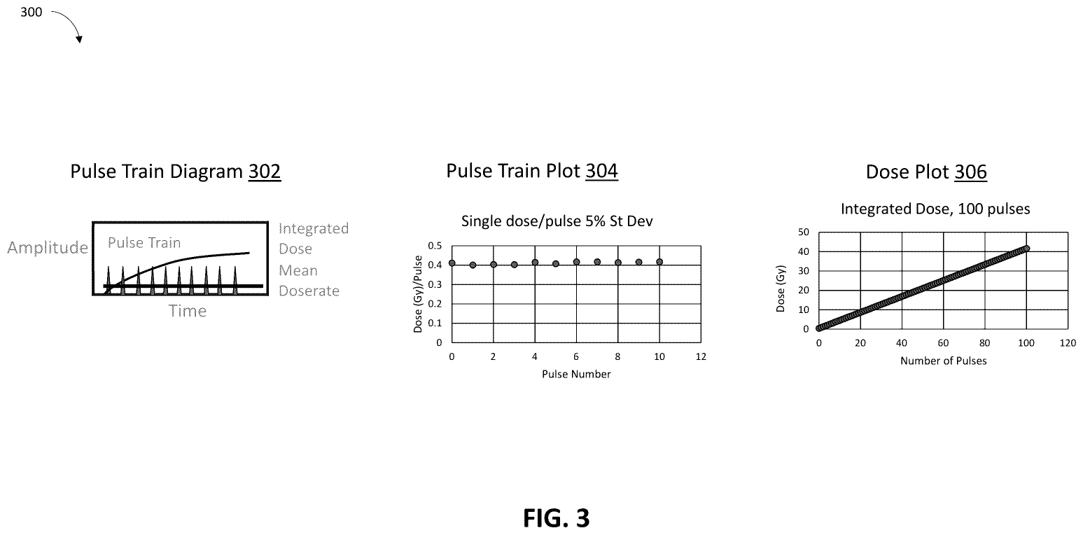

FIG. 3 shows an example pulse train diagram, an example pulse train plot and an example dose plot to convey an example accuracy of pulse-based particle beam sources in achieving a desired dose. More specifically, FIG. 3 shows a pulse train diagram 302, a pulse train plot 304, and a dose plot 306. FIG. 3 shows an example of how many small pulses summed together can result in accurate triggers that can be controlled to cease irradiation to a target from a particle beam source at a defined pulse limit. The pulse train diagram 302 shows short pulses of a pulse duration (also referred to as peaks herein) in the range of about 1 femtosecond and 999 microseconds that are sent periodically in time with a given amplitude. The pulse train diagram 302 and pulse train plot 304 show 5% standard deviation between pulses. The time between pulses can be used to measure a dose on a detector/sensor of a target and to determine whether to fire an additional pulse. In some implementations, the incremental dose from many small peaks (e.g., 100 pulses, about 10 nanoseconds in length, over a duration of 1 second) as measured by a detector/sensor (e.g., the detectors/sensors 120, 130) can be accurate, for example, to within 1% uncertainty, or within one pulse of the cumulative dose.

The periodic intensity shown in pulse train diagram 302 can be referred to for example as a ‘picket fence’ radiation pulse. The individual peaks have a voltage amplitude that can be many times greater than the average voltage amplitude for a pulse train, where the average voltage amplitude is an amount indicated by the user. A voltage or signal trace with peaks and valleys consistently shows peaks greater than the average voltage or signal. The more peaks and valleys that define the average, the more accurate the average is. The summation corrects in real time for the variation in pulses shown in the peaks and valleys of a pulse train diagram 302. By summing individual pulses, a particle accelerator system (e.g., the particle accelerator system 100 of FIG. 1) removes the uncertainty generated by variation in the accelerator production from pulse to pulse or during the pulse train. Thus, the combination of accelerator and sensor allows the variance or variations in the accelerator to be compensated for or controlled.

A target, for example, may be a disease site of a patient. A disease site, for example, may be a cancer site. The use of a detector/sensor (e.g., detector/sensor 120, 130 of FIG. 1) to measure individual pulses enables a desired improvement in precision and accuracy such that operation of a particle accelerator system can be stopped prior to an additional unnecessary pulse fire and therefore limit the range of the dose delivered.

In some implementations, a detector/sensor (e.g., detector/sensor 120, 130 of FIG. 1) can be sensitive to a characteristic(s) of the radiation on target. For example, a thermocouple junction or thermopile (an array of junctions) or semiconductor detector. Thermocouple junctions are sensitive to temperature in a way that is fixed by the physical characteristics of the materials used (NiCd as one example). Generally, thermocouples are not sensitive to the minute changes from radiation.

Pulsed radiation can provide, for example, a method for very accurately treating cancerous growths, allowing treatment of cancer with nominally a 1% uncertainty (error bar) vs. the 6% uncertainty that is known. There are multiple endeavors, in addition to cancer treatment, where this level of accuracy is desired.

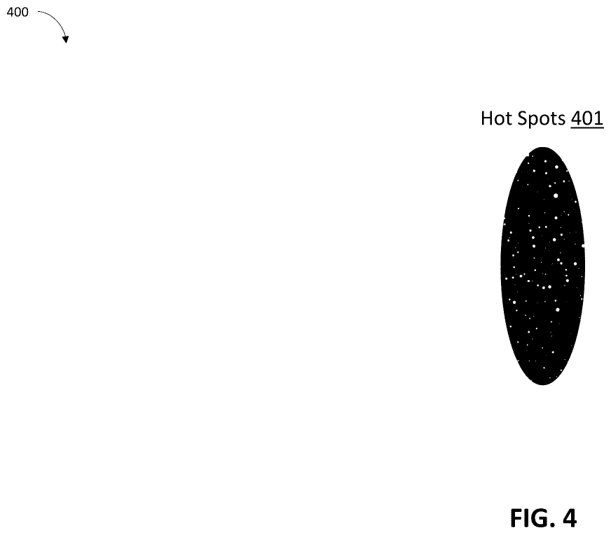

FIG. 4 is an example representation of a non-uniform distribution of hot spots 401, or beamlets, on a known extended area particle beam source. Each beamlet is uniquely associated with a position on an electrode surface of a particle beam source. The bright spots (shown as white spots) in FIG. 4 represent example positions of intense beam current spots (referred to as hot spots herein). The high contrast among hot spots illustrates the local heating variations which are desired to be reduced. In other words, the white spots reflect a random patterns of hot spots where most of the emission comes from in this example, which is an electron source. Such random patterns of hot spots can be typical in known Flash X-Ray) FXR devices and it illustrates the hotspot problem to be minimize by one or more embodiments discussed herein.

For a sense of what the hot spots 401 look like in FXR devices, see for example a published result in Houck. T., et al. “Design of a High Field Stress, Velvet Cathode for the Flash X-Ray (FXR) Induction Accelerator”, 2007 IEEE Particle Accelerator Conference (PAC), IEEE, 2007. Visible emission from typical large area cathodes as used in FXR (Flash X Ray Machines) designs (for an electron beam) where the electrons are generated either from a cold cathode or thermal mechanism) show features of hotspots in the image. The hot spots heat and take damage, generating variance between pulses, reducing lifetime, and increasing maintenance costs of intense particle accelerators.

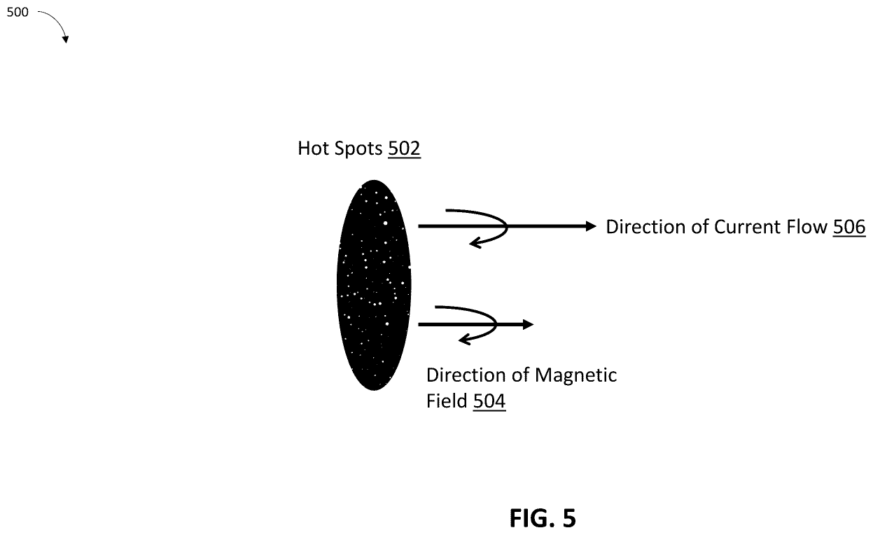

FIG. 5 shows a representation of the resulting forces generated by a non-uniform distribution of hot spots 502 of a known extended area particle beam source. The hot spots 502 generate locally-high magnetic fields. In known systems, these magnetic fields can become ‘frozen’ in place until the hot spots overheat and then lose the ability to emit particles as compared to nearby hot spots. The surface of the particle beam source can be, for example, concave or convex. The hot spots 502 form along the grain boundaries and sharp features of a source electrode surface. Each hot spot has a high local magnetic field 504, resulting in the beamlet to have a magnetic focusing or freezing effect that fixes the beamlet in its initial position. The beamlet, fixed in place, increases the local surface temperature, which in turn generates plasma. The plasma heats the surface damaging the structure. The field then self-organizes to find and generate a new hot spot. Overall this can degrade the performance of a particle beam source. It is the local high magnetic field around the hot spot that acts as a resistance to the hot spot moving. The high currents cannot move away from sharp tips or points in known particle beam sources. In contrast, one or more embodiments, with the spiral structure or variants can move high currents away from sharp tips or points. The shape of the spiral structure can be designed/selected to control the balance of electric versus magnetic fields to minimize the hot spot formation.

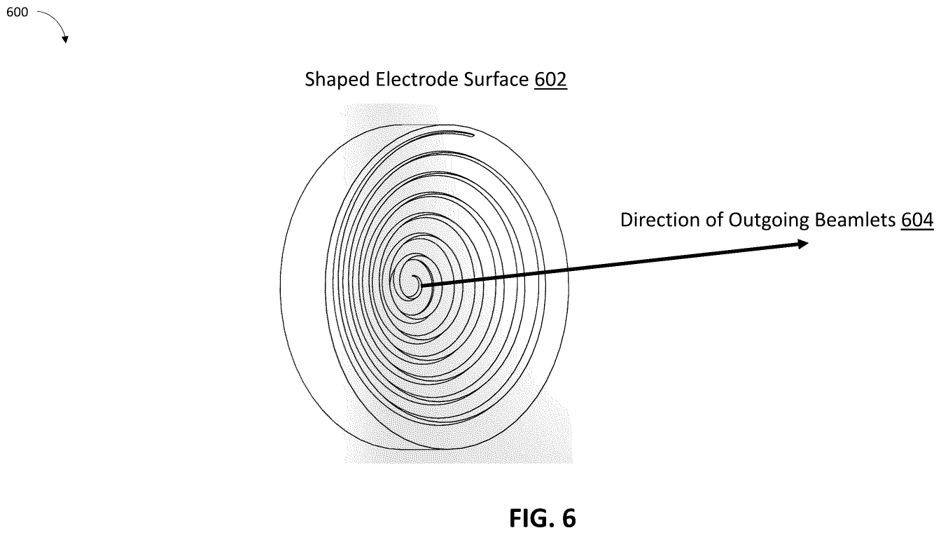

FIG. 6 shows a shaped electrode surface of a particle beam source, according to an embodiment. The shaped electrode surface 602 of a particle beam source (e.g., the particle beam source 104 of FIG. 1) is a contoured, spiral-wound electrode surface. The contours of the electrode surface can control the forces of the local magnetic fields and electric fields to move hotspots along gradients to ‘unfreeze’ local hot spots. In other words, a contoured, spiral-wound electrode surface provides control of the beamlet formation on an emission surface as the pulse voltage changes, unlike known surfaces of particle beam sources with flat cathodes that maintain the emission throughout the pulse, leading to localized heating. The controlled contours and shapes of the roughly spiral pattern, including portions of low spatial-frequency and portions of high-spatial frequency, relieve the forces that otherwise freeze the location of the beamlets during formation. High applied fields can be used to extract particles from the shaped electrode surface 602 rather than small spatial features, which are used in many known particle beam sources. The gradient of controlled contours and spiral pattern of the shaped electrode surface 602 facilitates movement of the hot spots from sharp portions with high spatial frequency to smooth portions with low spatial frequency prior to a local thermal overheating, which in turn enhances the lifetime of particle beam sources and enables scalable large area particle beam sources. Additionally, the concavity of the shaped electrode surface 602, whether concave, flat, or convex, can allow control of local electric fields to balance the tendency of the magnetic fields to freeze the location of the beamlets. The shaped electrode surface 602 is not to scale. Generally, geometric features are too small to show the shapes in such an illustration. Multiple nested spirals and high spatial frequency geometric features closer together can be appropriate in practice. The pinching magnetic field of the particle beam source (e.g., the particle beam source 104 of FIG. 1) balances the beamlets hotspots' self-field force and drives the beamlets to move before the thermal forces at the emission tips ‘explode’ the tips surfaces.

Known sources and targets use a high spatial-frequency substrate such as microstructures, microtips or velvet to provide localized high-electric field enhancement at the surface. This generates the lifetime limiting problem relieved by one or more embodiments described herein. The location of peak emission tends to be fixed causing micro spot emission and localized heating. Once the conditions giving rise to the hot spot is removed (because of local heating and disruption of the surface and plasma expansion), another spot initiates high local current and a new location is heated. In one or more embodiments of a particle beam source (e.g., the particle beam source 104), as the localized Child-Langmuir limits are reached, there is a lower energy barrier of the peak emission and the emission moves along the spiral of the shaped electrode surface 602, reducing the hot spot and providing controlled emission along the large area cathode surfaces.

A shaped electrode surface 602 can be made from any surface, for example one with a low work function and refractory characteristics. In some implementations, microtip structures can be used if appropriately organized in a variation of the spiral pattern of the shaped electrode surface 602. It does not need to be the uniform contoured shape of the electrode surface 602.

The expressions controlling the contours and spiral pattern of a shaped electrode surface 602 have a term in them describing the tangent of the angle of the radial force from the large magnetic field with the local forces holding the beamlet in place. The contours and spiral pattern of a shaped electrode surface 602, properly designed/configured (e.g., shaped, sized, etc.), balance the forces that fix the magnetic field against the pinch effect from a large area particle beam source such that any beamlets start to move quickly as the hotspot begins to expand, before they overheat the materials and drive the local surface to explode. The balance of forces protects each sharp emission point on the particle beam source and increases the lifetime at high current densities.

The shaped electrode surface 602 is structured in three dimensions and is shown with the surface slightly concave. A surface can be flat, concave, or convex depending on beam focus requirements. The concavity or convexity of the electrode surface 602 can at least in part control/define the temporal shape of a pulse and the beam focusing. The size of the contour edges can, for example, control/define current density profile. At functional scales, in some implementations, the edges of the contours are about 0.05 microns to 10 microns and the spirals can be nested. In implementations where the particle beam source emits ions, the contour edges for example can be about 1 micron. In other implementations where the particle beam source emits electrons, the contour edges for example can be about 20 microns. The spiral pattern of the shaped electrode surface 602 does not capture the optimized radial profile. The profiles are only roughly spirals. The optimal shape can be, for example, specifically where the contours are dominated by balancing the magnet force which fixes the location of the hot spot (much like the location of a solar flare stays relatively fixed against the applied electric field force) which is extracting the current in the beamlet. The magnetic field focuses the beamlet axially, while the radial and azimuthal forces are generated through the applied electric field and push orthogonally against the magnetic field, gently, but enough to move the hot spot along the spiral.

What this spiral design does is generate slight radial and azimuthal forces or pinch effects and instabilities such as the diocotron instability, from the large area source envelope against the very high local magnetic forces, which are caused by the high local current at the hot spot. The pinching combined with the radial and azimuthal effects push against the magnetic forces, allowing the hot spots to slide along the spiral, rather than staying in one space until it overheats.

The angle between the radial and azimuthal forces can be given as the local tangent of the angle given by the ratio of the potential energy between two beamlets divided by the pinch and electric field forces determines the relative strength of the forces freezing the beamlets in place to the more global forces pushing the beamlets to the center. This is what is used to design the tightness of the spiral and determine the local angle or pitch of the spiral surface.

When properly balanced the ‘beamlets’ can move along the spiral of the shaped electrode surface 602 before the local heating causes damage. In this way high reproducible currents, current densities and lifetime can be obtained.

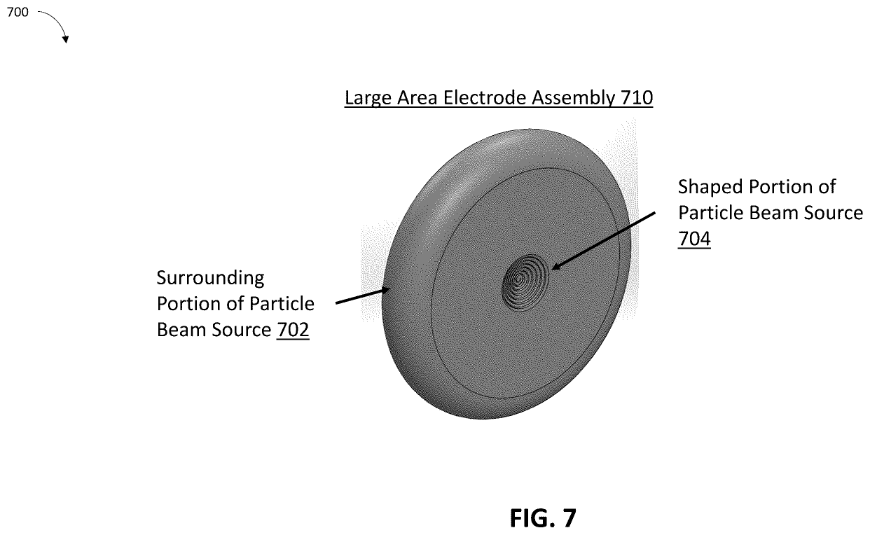

FIG. 7 shows a representation of how a shaped electrode surface (e.g., the shaped electrode surface 602 of FIG. 6) can be positioned in a large area electrode assembly 710 of a particle beam source (e.g., the particle beam source 104 of Figure), according to an embodiment. This allows the highest fields to be localized where particle are emitted from the incoming power feed (not shown). In some implementations, the first and second portions of a shaped electrode surface 704 are surrounded by a third portion 702 of the electrode assembly 710. The third portion 702 is mutually exclusive of the shaped electrode surface 704 and does not emit particles. The third portion 702 and its shape can reduce the electric field in locations on the large area electrode assembly 710 to localize emission to where it is desired. The third portion 702 can control/define at least in part the power flow of the radiation emitted. The opposing electrodes, which guide the power flow in the particle source, are not shown.

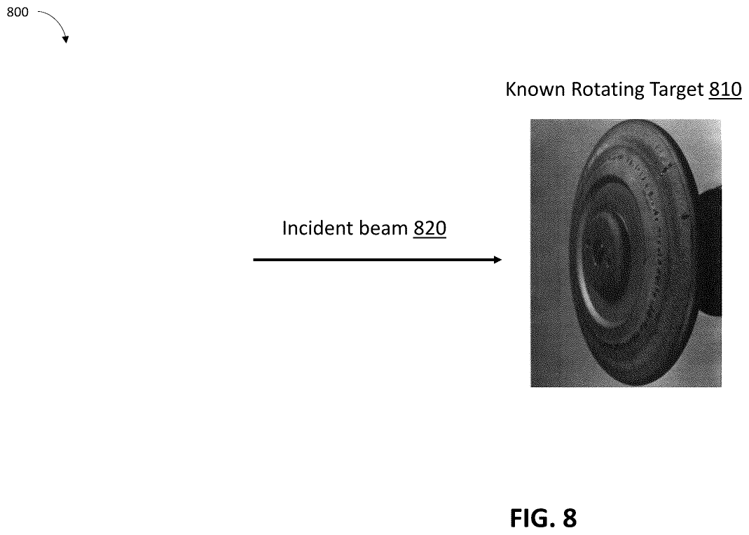

FIG. 8 shows a reference photo of a used known rotating anode (target for an electron beam as example) 810. When an incident beam 820 strikes the target, that beam heats the target, potentially pitting the target, sometimes significantly, as shown in FIG. 8. The image of the known rotating anode 810 is available from open-source references; see also U.S. Pat. No. 5,592,525, which is incorporated herein by reference. The anode rotates along an axis parallel to the direction of the beam hitting it.

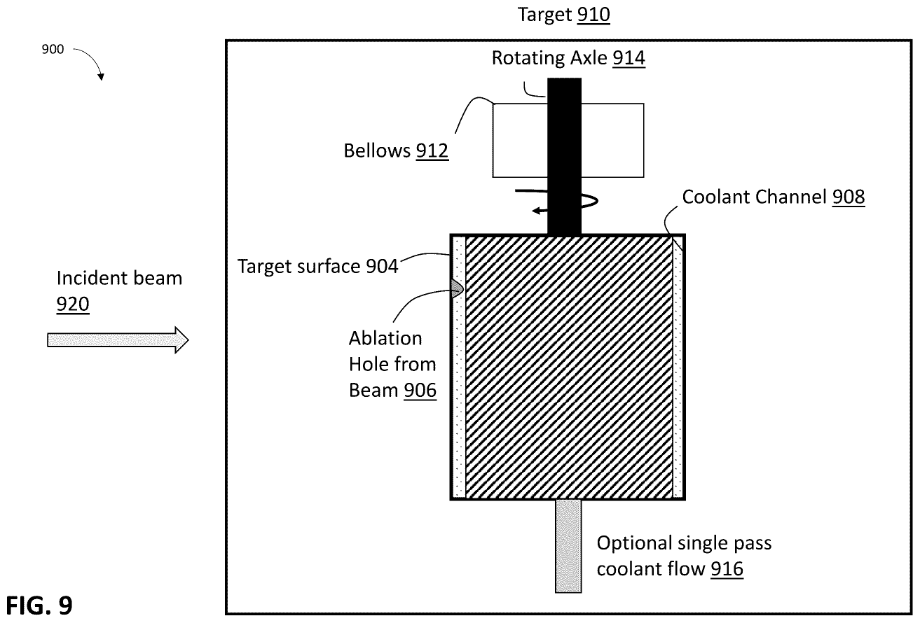

FIG. 9 shows a cross-sectional side view of a target 910, according to an embodiment. The target 910 is roughly a cylinder and has a curved target surface 904 (also referred to herein as a sidewall) and two bases (also referred to herein as sides such as a top side and a bottom side), one opposite to the other. The target 910 has a rotational position and a translational position that can be adjusted by means of a rotating axle 914 and/or a bellows 912. The target 910 is rotationally positioned such that the target surface 904 is substantially perpendicular to the direction of an incoming beamlet 920. In some implementations, the rotating axle 914 can position the target surface 904 rotationally at a parallel angle (also referred to as on-axis herein) or, in other implementations, at a non-parallel angle (also referred to as off-axis herein), depending on the desired result. For example, when the target is a neutron source the beam might be oriented to strike a target on-axis to substantially maximize yield and reduce spot size, while for limited penetration, x-rays oriented off-axis may improve signal at the sensor. As shown in FIG. 9, target 910 includes (defines) a coolant channel 908 that is disposed about a portion(s) of target 910 to circulate coolant about the target surface 904. The coolant channel 908 is sufficiently contained in the target 910 so that ablation 906 of the target surface 904 does not cause coolant to leak. Additionally, or alternatively, target 910 can also include (define) an optional single pass coolant flow(s) 916. The improved cooling compared to the cooling in known targets, through introduction of coolant flow through coolant channels 908, can result in much higher time-averaged power being tolerated. The target 910 can improve operating lifetimes and reduce the maintenance resulting from incident high power beams.

The need for higher power particle beam accelerators is known. The higher-powered beams, striking a known target, reach such power density that a single pulse can destroy the material in the target, by ablation, melting, evaporation or explosive mechanisms. Ablation 906 is represented on the target 910.

An extreme limit is that which happens in an inertial confinement fusion target (ICF) where a target is vaporized in each pulse. Backing away for that extreme, a need is for a system whereby a device can function for many shots even when the surface is disrupted without maintenance or target replacement. With this design the target can be long, leaving untouched material for long life operation without needing maintenance.

The target 910 can handle many pulses. For example, a 5 cm diameter rotating target 910 that is 8 cm in length with 120 cm² surface area may receive at a first target position 1.2×10⁴ pulses of a 1 mm² area focused beam pulse before receiving pulses from an additional beam pulse at the first target position a second time.

Under conditions where the beam footprint in a pulse(s) is low enough that the target surface 904 can withstand many pulses, the movement of the target 910 will allow the target surface 904 to cool before the next pulse impacts the target surface 904, extending the lifetime of the target 910 by changing the radial and/or translational position of a target 910. The cooled target surface 904 can then be impacted by more beam pulses, which enhances the lifetime of the target 910.

Even if one beam pulse on the target location becomes unsuitable for a second pulse, by moving the target location the target survives at a low enough maintenance cost to be useful. For example, the target shown can handle thousands to millions of pulses without refurbishment or replacement even when the surface is disrupted by a single pulse. In effect, the mobility of a target 910 enhances the surface area struck by the beam, increasing the acceptable damage imparted to a target 910 prior to maintenance. A steady state beam can carry roughly the vertical adjustment in height of the beam on the target 910 divided by the beam height additional power than known rotating targets.

Some implementations of a target 910 can alleviate current issues in accelerator performance and offer opportunities for solutions that will, for example, enhance U.S. security and prosperity. For example, implementations of a target 910 can be useful where sealed accelerators are used such as for oil-well logging or compact nuclear activation as well as for larger installations, such as isotope generation or Heavy Ion Fusion, where there is space and power for vacuum pumping and cooling. Additional applications of an improved particle accelerator system (e.g., the particle accelerator system 100 of FIG. 1) may include, for example, replacement for x-ray and gamma isotopic radiation sources, sources for flash radiography, cancer treatment, and industrial radiography. Regarding ion sources, needs exist, for example, in materials science, neutron generation, inertial confinement fusion and basic science, national security in cargo and portal scanners as well as simulation sciences regarding high energy density physics.

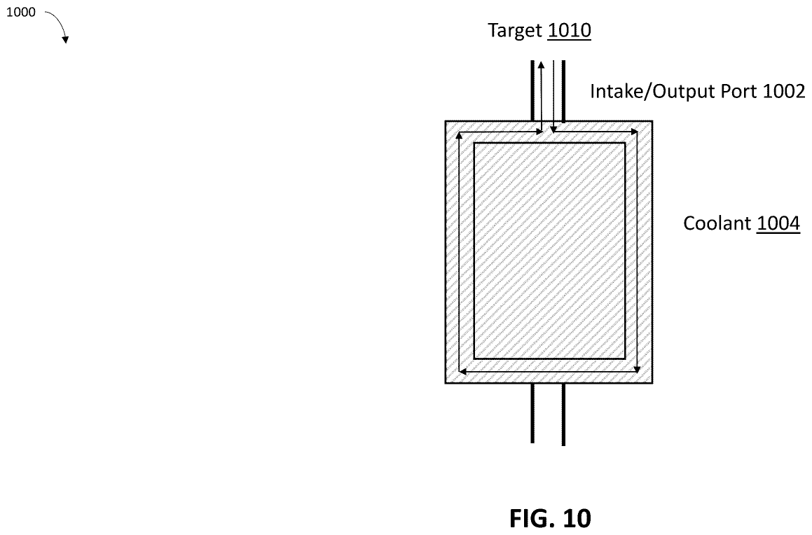

FIG. 10 shows a cross-sectional side view of a target 1010 (e.g., the target 910 of FIG. 9) with a single port 1002 that can intake and output coolant 1004 about a portion of the target 1010, according to an embodiment.

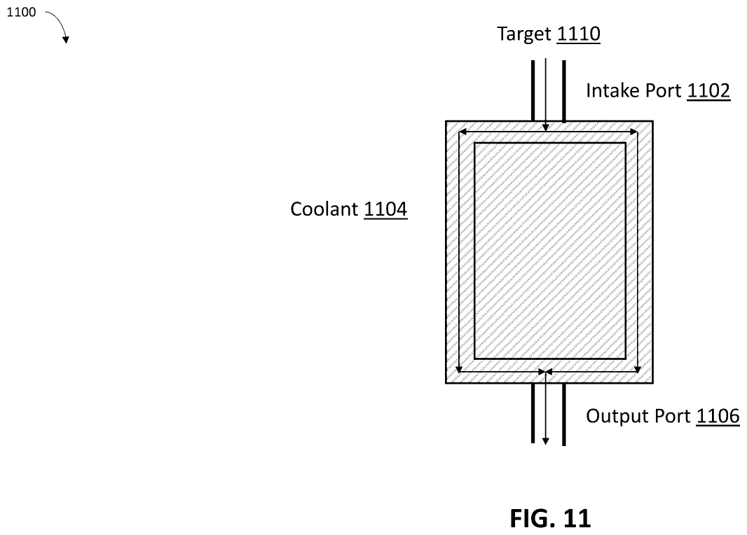

FIG. 11 shows a cross-sectional side view of a target 1110 (e.g., the target 910 of FIG. 9) with two ports, according to an embodiment. An intake port 1102 can intake coolant 1104 about a portion of the target 1110 and an output port 1106 can output coolant 1104 from the target 1110.

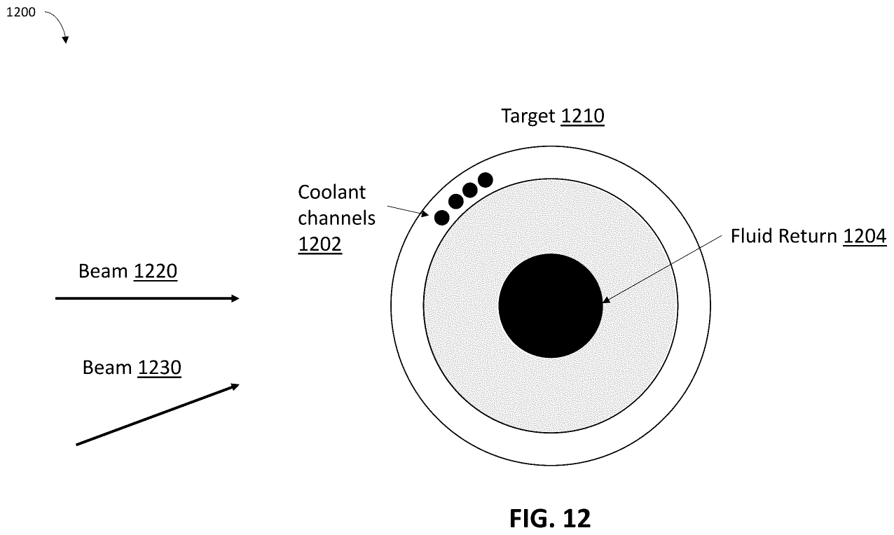

FIG. 12 shows a top-down view of a target 1210 with coolant channels 1202 along the perimeter of the target 1210, according to an embodiment. The target 1210 also has a port 1204 (also referred to herein as “fluid return”) that can intake and/or output coolant. The coolant channels 1202 can improve control of the coolant flow and promote laminar flow. In some implementations, some coolant channels can be used as intake ports, and the remaining other coolant channels can be used as output ports. For example, every other coolant channel among adjacent coolant channels can intake coolant, and every remaining other coolant channel can output coolant. Other combinations can be used. For example, coolant channels 1202 can intake coolant and output coolant from the fluid return port 1204. In another example, the fluid return port 1204 can intake coolant, circulate coolant through the coolant channels 1202, and output coolant 1204 from the coolant channels 1202. Incident beams 1220,1230 can strike the target 1210 on-axis or off-axis, depending on the application to tailor the emission spot (whether neutron or photons or other particle). In some implementations, the beams 1230 for example can be electrons or deuterium ions that can strike the target 1210 off-axis. In the gas of electrons as the beam particle, the output may be x-rays or gamma rays, and in the case of deuterium ions, the target surface can contain deuterium to make 2.5 MeV neutrons or even tritium where the impacting deuterium on tritium makes 14 MeV neutrons.

The drawings primarily are for illustrative purposes and is not intended to limit the scope of the subject matter described herein. The drawing is not necessarily to scale; in some instances, various aspects of the subject matter disclosed herein can be shown exaggerated or enlarged in the drawing to facilitate an understanding of different features.

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

What is claimed is:

1. An apparatus, comprising:
a particle accelerator having a particle beam source and a target, the particle accelerator configured to output radiation in at least one pulse,
the particle beam source having an electrode surface, the electrode surface having a first portion and a second portion, the first portion of the electrode surface defining a spiral pattern with high spatial-frequency contours, the second portion of the electrode surface defining a spiral pattern with low spatial-frequency contours.

2. The apparatus of claim 1, wherein the second portion of the electrode surface lacks a point with at least one of a geometric feature substantially less than 1 micron or a smoothness less than 20 microns.

3. The apparatus of claim 1, wherein:
the particle accelerator is configured to output the emitted radiation and reduce dominance of beamlets in overall radiation production.

4. The apparatus of claim 1, wherein:
the particle accelerator is configured to output the radiation and reduce dominance of beamlets in overall beam production,
the spiral pattern with high spatial-frequency contours sized and positioned to cause a plurality of beamlets of the radiation to move about the electrode surface to reduce localized overheating during operation of the particle source.

5. The apparatus of claim 1, wherein:
the electrode surface includes a third portion mutually exclusive from the first portion and the second portion of the electrode surface,
the third portion of the electrode surface surrounding the first portion and the second portion of the electrode surface.

6. The apparatus of claim 1, wherein:
the electrode surface includes a third portion mutually exclusive from and surrounds the first portion and the second portion of the electrode surface,
the particle accelerator configured to output particles of the radiation from the first portion and the second portion of electrode surface and not from the third portion of the electrode surface,
the third portion of the electrode surface sized and configured to define, at least in part, power flow of the radiation during operation of the particle accelerator.

7. The apparatus of claim 1, wherein:
the electrode surface has a concavity or convexity,
a shape of the at least one pulse being defined, at least in part, based on the concavity or convexity of the electrode surface.

8. The apparatus of claim 1, wherein:
the particle beam source is configured to output substantially along a first axis the radiation having a first pulse at a first time and a second pulse at a second time different from the first time,
the target is configured to at least one or rotate or translate along a second axis that is non-parallel to the first axis, the target is configured to be at a first position when the first pulse is incident on the target and at a second position when the second pulse is incident on the target, the second position different from the first position by at least one of a rotational position or a translational position.

9. The apparatus of claim 1, wherein the target includes a coolant channel disposed about at least a portion of a perimeter of the target and configured to circulate coolant during operation of the particle beam source.

10. The apparatus of claim 1, wherein:
the target includes a coolant channel disposed about at least a portion of a perimeter of the target and configured to circulate coolant during operation of the particle beam source,
the target having a first side and a second side opposite the first side, the target having an intake port and an output port disposed at the first side.

11. The apparatus of claim 1, wherein:
the target includes a coolant channel disposed about at least a portion of a perimeter of the target and configured to circulate coolant during operation of the particle beam source,
the target having a first side and a second side opposite the first side, the target having an intake port disposed at the first side and an output port disposed at the second side.

12. An apparatus, comprising:
a particle beam source configured to be included in a particle accelerator that includes a target,
the particle beam source having an electrode with an electrode surface, the electrode surface having a first portion and a second portion, the first portion of the electrode surface defining a spiral pattern with high spatial-frequency contours, the second portion of the electrode surface defining a spiral pattern with low spatial-frequency contours,
the particle beam source configured to output radiation in at least one pulse towards the target.

13. The apparatus of claim 12, wherein:
the particle accelerator is configured to output the radiation having a plurality of beamlets,
the second portion of the electrode surface lacks a sharp point and is sufficiently smooth to allow beamlets from the plurality of beamlets to move about the electrode surface before overheating during operation of the particle accelerator.

14. The apparatus of claim 12, wherein:
the particle accelerator is configured to reduce a portion of the output radiation due to intense beamlets from a plurality of beamlets of the output radiation and to generate more uniform heating at the source surface,
the spiral pattern with high spatial-frequency contours sized and positioned to cause the plurality of beamlets to move about the electrode surface before overheating during operation of the particle accelerator.

15. The apparatus of claim 12, wherein:
the electrode surface includes a third portion mutually exclusive from and surrounds the first portion and the second portion of the electrode surface,
the particle accelerator configured to output particles of the radiation from the first portion and the second portion of electrode surface and not from the third portion of the electrode surface,
the third portion of the electrode surface sized and configured to define, at least in part, power flow of the radiation during operation of the particle accelerator.

16. An apparatus, comprising:
a target configured to be included in a particle accelerator that includes a particle beam source that is configured to output, substantially along a first axis, radiation having a first pulse at a first time and a second pulse at a second time different from the first time,
the target is configured to at least one or rotate or translate along a second axis that is non-parallel to the first axis, the target is configured to be at a first position when the first pulse is incident on the target and at a second position when the second pulse is incident on the target, the second position different from the first position by at least one of a rotational position or a translational position.

17. The apparatus of claim 16, wherein the target includes a coolant channel disposed about at least a portion of a perimeter of the target and configured to circulate coolant during operation of the particle beam source.

18. The apparatus of claim 16, wherein:
the target includes a coolant channel disposed about at least a portion of a perimeter of the target and configured to circulate coolant during operation of the particle beam source,
the target having a first side and a second side opposite the first side, the target having an intake port and an output port disposed at the first side.

19. The apparatus of claim 16, wherein:
the target includes a coolant channel disposed about at least a portion of a perimeter of the target and configured to circulate coolant during operation of the particle beam source,
the target having a first side and a second side opposite the first side, the target having an intake port disposed at the first side and an output port disposed at the second side.

20. A method, comprising:
outputting radiation in at least one pulse from a particle beam source of a particle accelerator to a target of the particle accelerator, the at least one pulse having a pulse width between about 1 femtosecond and 999 microseconds,
the particle beam source having an electrode surface, the electrode surface having a first portion and a second portion, the first portion of the electrode surface defining a spiral pattern with high spatial-frequency contours that controls power flow into the particle beam source; and
receiving the radiation from the particle beam source and at the target.
